(19) United States
(12) Patent Application Publication
(10) Pub. No.: US 2026/0257605 A1
(43) Pub. Date: Sep. 3, 2026

(54) MATERIAL TRANSPORT VEHICLE AND MOTOR ASSEMBLY FOR SUCH A VEHICLE

(71) Applicant: PULLOAD BV, Pajottegem (BE)

(72) Inventor: Marc DELTOMME, Buggenhout (BE)

(21) Appl. No.: 19/157,072

(22) PCT Filed: Feb. 15, 2024
(86) PCT No.: PCT/EP2024/053937

§ 371 Date: Aug. 15, 2025

(30) Foreign Application Priority Data
Feb. 16, 2023 (EP) 23157077

(51) Int. Cl. B60P 1/00

(52) U.S. Cl. CPC B60P 1/006

(57) ABSTRACT

Vehicle on which a container (1) for transporting materials is mounted, said container including a movable partition (10) extending transversely inside the container. The vehicle includes a first traction assembly (MT1) capable of pulling on a pair of cables (14a, 14b) the front parts of which are connected on either side of the partition (10) in order to pull the partition (10) towards the rear of the container to discharge materials.

The vehicle also comprises a second traction assembly (MT2) capable of pulling on one or more cables (14c, 14d, 14e, 14f) the front part(s) of which are connected to the partition (10) in order to pull the partition (10) towards the front of the container in order to place it again in an initial position at the front of the container.

### FIELD OF THE INVENTION

The invention relates to the field of vehicles including a container for loading, transporting and unloading materials. More particularly, the invention relates to such a vehicle including means for unloading said materials without having to move the container.

### PRIOR ART

Tipper trucks for transporting materials are for example known. However, these vehicles are unsuitable when unloading locations are tight and do not allow tipping (tilting the hopper), such as in a tunnel or building. In addition, tipping poses many safety issues, including the risk of the vehicle tipping over, for example when it is on uneven ground and/or in high winds.

To overcome these disadvantages, vehicles have been designed whose container intended to contain the materials has a movable partition which can be moved forwards and backwards by force inside the container in order to unload the materials through a rear door of the container without having to tip the container.

Such a vehicle is known from U.S. Pat. No. 4,078,682. The container of this vehicle has a movable transverse partition which can be moved by means of a set of traction cables connected via a set of pulleys to a motor. Nonetheless, the cables and the motor of this vehicle are designed to move the partition in only one direction.

Swiss patent CH446182 describes a refuse truck with a tipping container. The container includes a movable partition which is pulled backwards by means of a pair of endless chains actuated by a hydraulic motor. In order to be able to move the partition in both directions (from front to rear and from rear to front), the motor must be able to rotate in both directions, which is not always possible with a hydraulic motor.

### SUMMARY OF THE INVENTION

One of the aims of the invention is to provide a vehicle provided with a container comprising a movable partition which can be pulled towards the front and towards the rear of the container, in particular when the force to be applied to the movable partition should be much greater when it is pulled backwards to unload materials contained in the container, than when the movable partition is pulled forwards to return it to its initial position.

The invention is defined by the independent claims. The dependent claims define preferred embodiments of the invention.

According to the invention, a vehicle is provided including a container for loading, transporting and unloading materials, said container extending longitudinally along a front-rear axis of the vehicle and including a left side wall and a right side wall, a rear wall opening for unloading said materials, and a movable partition extending transversely inside the container.

The vehicle also includes:
a first flexible mechanical connection a front part of which is connected to a left side of the partition and which first extends towards the rear of the vehicle, then upwards or downwards via at least one first pulley,
a second flexible mechanical connection a front part of which is connected to a right side of the partition and which first extends towards the rear of the vehicle, then upwards or downwards via at least one second pulley,
at least one third flexible mechanical connection a front part of which is connected to the partition and which first extends toward the front of the vehicle, then upwards or downwards via at least one third pulley,
a first traction assembly including a first motor and a first transmission, the first transmission having a first input connected to the first motor as well as a first output provided with a first winding means to which a left end of the first flexible mechanical connection is attached and a second output provided with a second winding means to which a right end of the second flexible mechanical connection is attached, the first transmission including at least one speed reducer for reducing the speed between the first input on the one hand and the first and second outputs on the other hand,
a second traction assembly including a second motor and a second transmission, the second transmission having a second input connected to the second motor as well as a second output provided with a third winding means to which an end of the third flexible mechanical connection is attached, the second transmission preferably including a speed reducer between the second motor (M2) and the third winding means (E3),
means of controlling the first traction assembly and the second traction assembly, the control means including a control unit.

Having two different traction assemblies each with a different function allows the movable wall to be moved in both directions, while providing more flexibility in vehicle design and enabling better optimisation, in particular in the selection and sizing of the motors. The second motor may for example have a power lower than the power of the first motor. The second motor may for example be a hydraulic motor and the first motor may for example be an electric motor.

The vehicle container is a container designed for loading, transporting and unloading solid and/or liquid materials. The container may be a skip, a container, a tanker, etc. In the case of a container designed for transporting and unloading solid materials, said container is preferably a box open or opening on at least one upper part.

Preferably, the vehicle includes means for reducing a resistive torque of the first traction assembly when and while the second traction assembly is put into action. This makes it possible to reduce the power required for the second motor, and thus limit its weight and/or its cost.

Preferably, the vehicle includes means for reducing a resistive torque of the second traction assembly when and while the first traction assembly is put into action. This makes it possible to reduce the power required for the first motor, and therefore to limit its weight and/or its cost.

Said means for reducing the resistive torque of the first and/or second traction assembly may be of different natures, examples of which will be provided below.

The invention also relates to a module or a kit comprising the first traction assembly and the second traction assembly as well as optionally a control unit, said module or kit being able to be mounted on a vehicle whose container is provided with the movable partition as well as the flexible mechanical connections.

### BRIEF DESCRIPTION OF THE FIGURES

These aspects as well as other aspects of the invention will become clearer in the detailed description of particular embodiments of the invention, reference being made to the drawings, wherein:

FIG. 1 is a schematic perspective view of a vehicle according to the invention;

FIG. 2 is a schematic cross-sectional view of the vehicle container of FIG. 1;

FIG. 3 is a view in longitudinal section of the container of FIG. 2, according to a first example embodiment;

FIG. 4 is a view in longitudinal section of the container, according to a second embodiment;

FIG. 5 schematically shows a first traction assembly and a second traction assembly of a movable partition according to an example of a vehicle according to the invention;

FIG. 6 schematically shows a first traction assembly and a second traction assembly of a movable partition according to another example of a vehicle according to the invention;

FIG. 7 schematically shows a first traction assembly and a second traction assembly of a movable partition according to yet another example of a vehicle according to the invention;

FIG. 8 schematically shows a first traction assembly and a second traction assembly of a movable partition according to yet another example of a vehicle according to the invention;

FIG. 9 schematically shows a first traction assembly and a second traction assembly of a movable partition according to yet another example of a vehicle according to the invention;

FIG. 10 schematically shows a first traction assembly and a second traction assembly of a movable partition according to yet another example of a vehicle according to the invention.

The drawings of the figures are neither to scale nor proportionate. In general, similar or identical elements are denoted by identical reference numerals in the figures.

### DETAILED DESCRIPTION OF EMBODIMENTS OF THE INVENTION

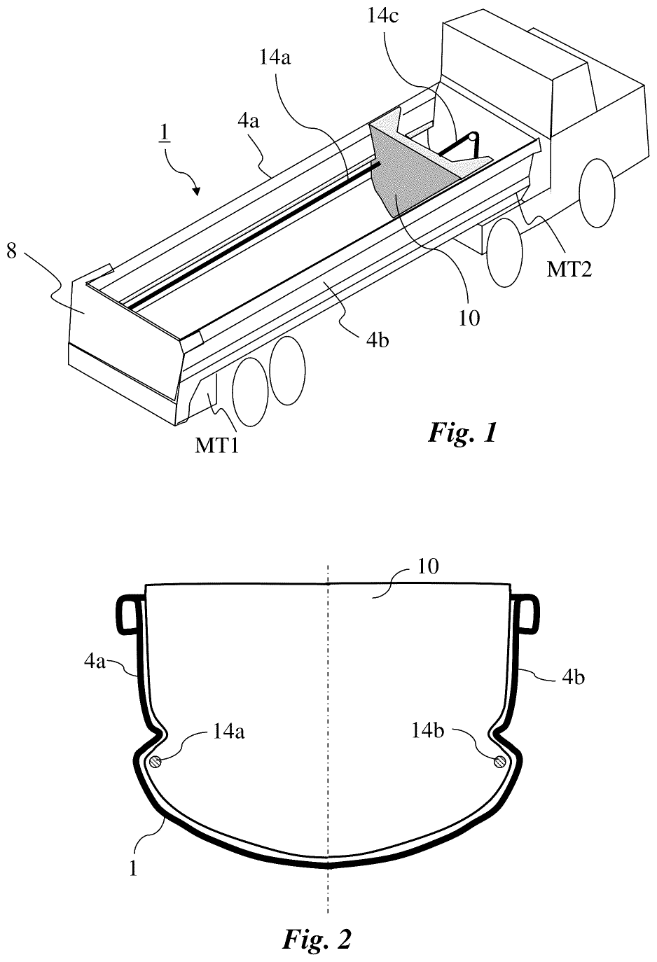

FIG. 1 shows a perspective view of an example of a vehicle according to the invention. The vehicle can be a truck, semi-trailer, waggon, tanker, etc.

The vehicle includes a container (1) for loading, transporting and unloading solid or liquid materials, preferably for solid materials. The container can be a skip, a container, a tank, etc. In the case of a container designed for loading, transporting and unloading solid materials, said container is preferably a box open or opening on at least one upper part of the container.

The container (1) extends longitudinally along a front-rear axis of the vehicle and has a length of for example between 4000 mm and 15000 mm, and a width of for example between 2000 mm and 3000 mm.

The container (1) includes a left side wall (4a), a right side wall (4b), and an opening rear wall (8) (e.g. a swing door) for unloading the materials.

The container (1) also includes a movable partition (10) extending transversely inside the container (1). This partition may for example be a simple metal plate, flat or curved and optionally provided with braces. The container (1) or the vehicle also includes flexible mechanical connections (14a, 14b, 14c, 14d, 14e) connected to the movable partition as well as two traction assemblies (MT1, MT2), the arrangements and functions of which will be detailed below.

The container (1) is preferably open or can be opened from above in order to be able to load the materials therein from above. The container (1) may for example be completely open from above or include a door or a tarpaulin or any other equivalent means allowing access to its inner volume from above.

Although FIG. 1 shows a container having a front wall that is opposite the rear face (8), this front wall is not essential since the movable partition (10) can act as a front wall. Preferably, the container does not include a front wall and in this case optionally includes cross members connecting the front ends of the left (4a) and right (4b) side walls and serving as reinforcements.

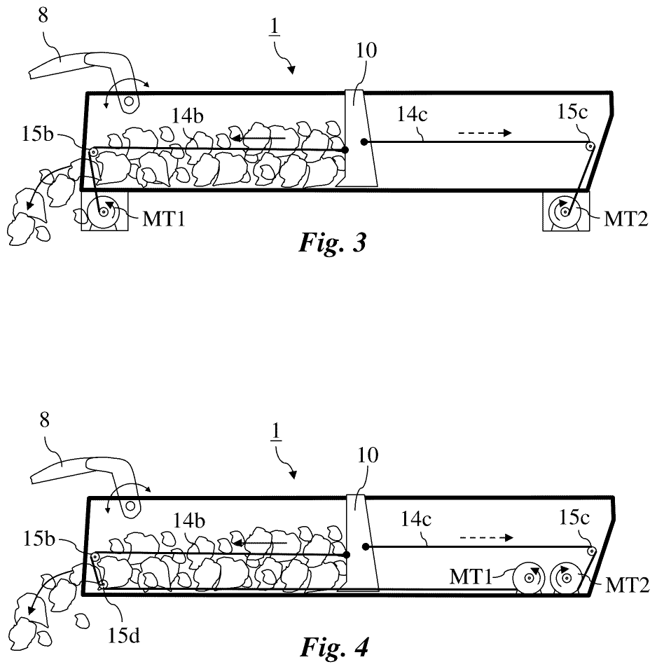

FIG. 2 is a schematic cross-sectional view of the vehicle container of FIG. 1. FIG. 3 is a longitudinal cross-sectional view of the vehicle container of FIG. 1, according to a first embodiment. For reasons of clarity, the vehicle is no longer shown in this and the following figures, but is of course present.

It can be seen therein that the container (1) or the vehicle also includes:
a first flexible mechanical connection (14a) a front part of which is connected to a left side of the movable partition (10) and which first extends towards the rear of the vehicle, then upwards or downwards via at least one first pulley (15a),
a second flexible mechanical connection (14b) a front part of which is connected to a right side of the partition (10) and which first extends towards the rear of the vehicle, then upwards or downwards via at least one second pulley (15b),
a third flexible mechanical connection (14c) a front part of which is connected to the partition (10) and which first extends toward the front of the vehicle, then upward or downward via at least one third pulley (15c),
a first traction assembly (MT1) including a first motor (M1) and a first transmission (T1), the first transmission having a first input connected to the first motor as well as a first output provided with a first winding means (E1) to which a rear end of the first flexible mechanical connection (14a) is attached and a second output provided with a second winding means (E2) to which a rear end of the second flexible mechanical connection (14b) is attached, the first transmission including at least one speed reducer (R1, R2) for reducing the speed between the first input on the one hand and the first and second outputs on the other hand,
a second traction assembly (MT2) including a second motor (M2) and a second transmission (T2), the second transmission having a second input connected to the second motor as well as a second output provided with a third winding means (E3) to which a rear end of the third flexible mechanical connection (14c) is attached, the second transmission preferably including a speed reducer (R3).

The vehicle also includes means of controlling the first traction assembly and the second traction assembly, the control means including a control unit (not shown).

For example, the control means comprise a switch with three positions, for example an “unload” position, a “neutral” position, and a “partition return” position.

When the control unit detects that the switch is set to the “unload” position, it will put into action the first traction assembly (MT1) to pull the movable partition towards the rear of the container, and it could, in the case of some examples described hereafter, put into action the means for reducing a resistive torque of the second traction assembly (MT2). First limit stop means may also be provided for safety reasons in order to stop the first traction assembly (MT1) and interrupt the travel of the movable partition when it reaches the rear of the container.

When the control unit detects that the switch is in the “partition return” position, it will put into action the second traction assembly (MT2) to pull the movable partition towards the front of the container, and it could, in the case of some examples described hereafter, put into action the means for reducing a resistive torque of the first traction assembly (MT1). Second limit stop means may also be provided for safety reasons in order to stop the second traction assembly (MT2) and interrupt the travel of the movable partition when it reaches the front of the container.

And when the control unit detects that the switch is in the “neutral” position, it will stop the first traction assembly (MT1) and the second traction assembly (MT2).

An emergency stop button may also be provided to stop any movement of the movable partition. The emergency stop button as well as the three-position switch will preferably be arranged in a location easily accessible to the driver of the vehicle.

In the example in FIG. 3, the first traction assembly (MT1) is mounted at the rear of the vehicle, while the second traction assembly (MT2) is mounted at the front of the vehicle.

FIG. 4 is a view of the container in longitudinal section, according to a second embodiment. This example is similar to that of FIG. 3, except that here the first traction assembly (MT1) and the second traction assembly (MT2) are both mounted at the front of the vehicle. In this example, two additional pulleys (15d, 15e) will be provided for to return the first and second flexible mechanical connections (14a, 14b) to the front of the vehicle.

In other examples (not shown), the first traction assembly (MT1) and the second traction assembly (MT2) are both mounted at the rear of the vehicle. In these, an additional pulley will be provided to return the at least one third flexible mechanical connection (14c) to the rear of the vehicle.

According to some examples, the vehicle according to the invention includes means for reducing a resistive torque of the first traction assembly (MT1) when and while the second traction assembly (MT2) is put into action. This makes it possible to use a second motor (M2) of lower power than in the absence of such means and therefore to reduce the cost and/or the price and/or the footprint thereof.

The following figures show in more detail the two traction assemblies (MT1, MT2), according to several exemplary embodiments including such means for reducing a resistive torque of the first traction assembly.

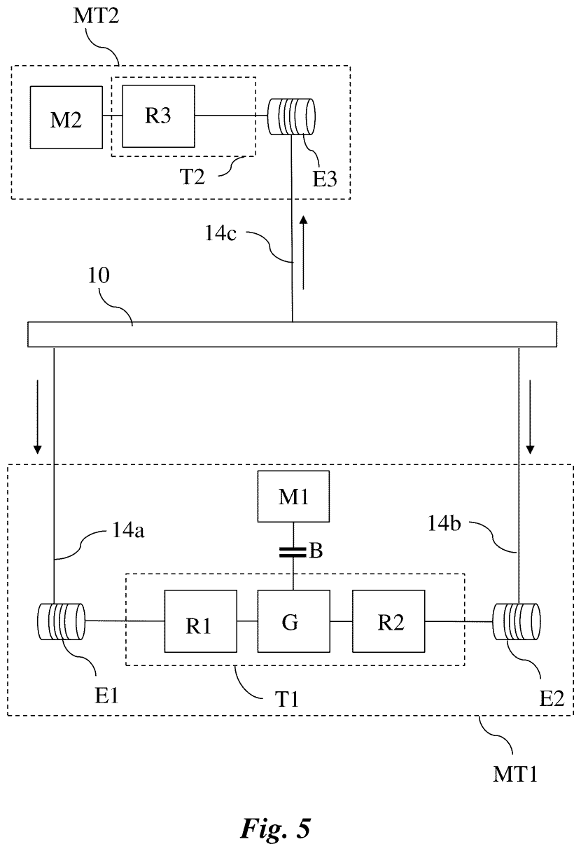

FIG. 5 schematically shows a first traction assembly and a second traction assembly of the movable partition (10) according to an example of a vehicle according to the invention. According to this example, the first traction assembly (MT1) comprises a clutch (B) mounted between the first motor (M1) and the first transmission (T1).

Preferably, the clutch (B) is a controllable clutch, and the control unit (not shown) is configured to engage the clutch (B) when and while the first traction assembly (MT1) is put into action and to disengage the clutch (B) when and while the second traction assembly (MT2) is put into action. Thus, when the second traction assembly (MT2) is in action to bring the movable wall back towards the front of the container, the resistive torque of the first traction assembly (MT1) will be reduced.

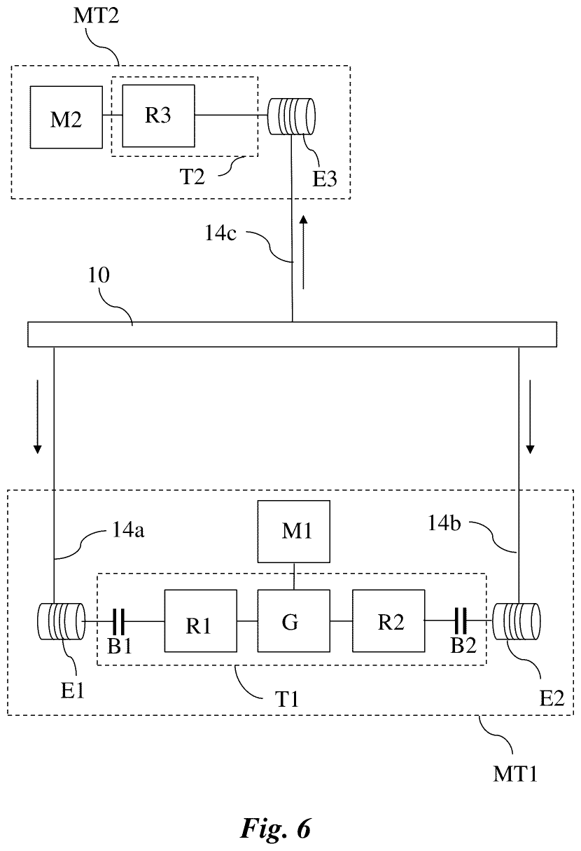

FIG. 6 schematically shows a first traction assembly and a second traction assembly of the movable partition (10) according to another example of a vehicle according to the invention.

According to this example, the first traction assembly (MT1) comprises:
a first speed reducer (R1) mounted between the first motor (M1) and the first winding means (E1),
a first clutch (B1) mounted between the first speed reducer (R1) and the first winding means (E1),
a second speed reducer (R2) mounted between the first motor (M1) and the second winding means (E2),
a second clutch (B2) mounted between the second speed reducer (R2) and the second winding means (E2).

Preferably, the first and second clutches (B1, B2) are controllable clutches, and the control unit is configured to engage the first and second clutches (B1, B2) when the first traction assembly (MT1) is put into action and to disengage the first and second clutches (B1, B2) while the second traction assembly (MT2) is put into action. Thus, when the second traction assembly (MT2) is in action to bring the movable wall back towards the front of the container, the resistive torque of the first traction assembly (MT1) will be reduced.

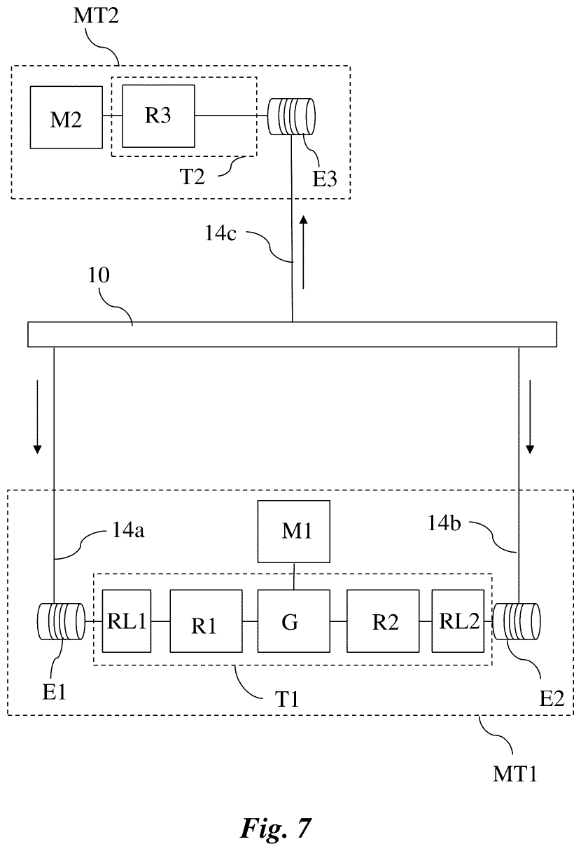

FIG. 7 schematically shows a first traction assembly and a second traction assembly of the movable partition (10) according to yet another example of a vehicle according to the invention.

According to this example, the first traction assembly (MT1) comprises:
a first speed reducer (R1) mounted between the first motor (M1) and the first winding means (E1),
a first freewheeling means (RL1) mounted between the first speed reducer (R1) and the first winding means (E1),
a second speed reducer (R2) mounted between the first motor (M1) and the second winding means (E2),-a second freewheeling means (RL2) mounted between the second speed reducer (R2) and the second winding means (E2).

The first freewheeling means (RL1) and a means (generally mechanical) allowing applying a motor torque to the first winding means (E1) when the first motor (M1) rotates in a first direction of rotation in order to pull on the first flexible mechanical connection (14a) (as indicated by a downward arrow on the connection 14a, to the left in FIG. 7) and removing or greatly reducing a resistive torque of the first traction assembly (MT1) when the second motor (M2) rotates in a direction of rotation in order to pull on the third flexible mechanical connection (14c) (as indicated by an upward arrow on the connection 14c, in FIG. 7), i.e. when an opposite traction is applied to the first flexible mechanical connection (14a) by the second traction assembly (MT2).

The same applies to the second freewheeling means (RL2).

Such freewheeling means are known and will therefore not be described in more detail.

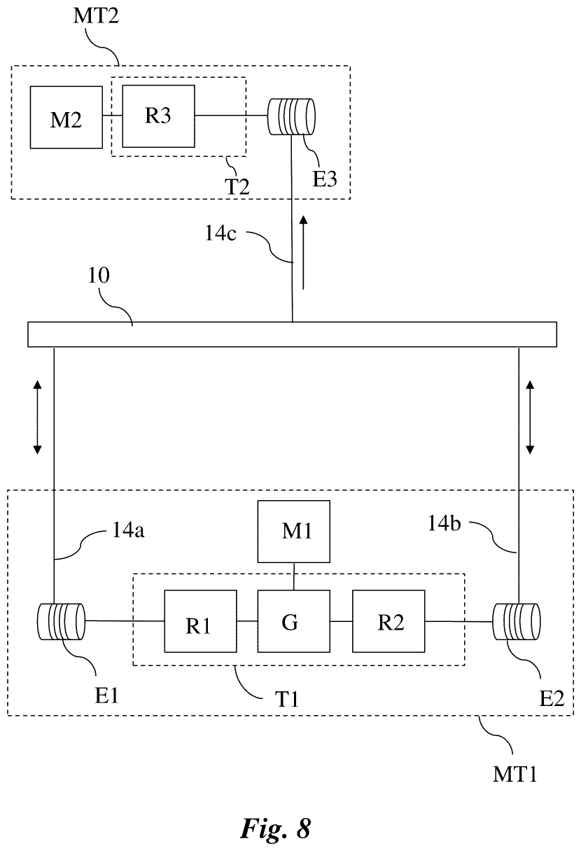

FIG. 8 schematically shows a first traction assembly and a second traction assembly of the movable partition (10) according to yet another example of a vehicle according to the invention.

According to this example, the first motor (M1) is capable of rotating in both directions of rotation and the control unit is configured to:
rotate the first motor (M1) in a first direction of rotation to pull the movable partition (10) towards the rear of the container (1), and to
rotate the first motor (M1) in a second direction of rotation opposite to the first direction of rotation when and while the second motor (M2) is put into action in a direction of rotation in order to pull on the third flexible mechanical connection (14c) to pull the movable partition (10) towards the front of the container (1).

This also allows removing or greatly reducing a resistive torque of the first traction assembly (MT1) when the second motor (M2) rotates in a direction of rotation in order to pull on the third flexible mechanical connection (14c) to pull the movable partition (10) towards the front of the container (1). According to this example, the first motor (M1) should not deliver much power when it rotates in the second direction of rotation; all it needs is that it accompanies the reverse rotation of the first winding means (E1) and of the second winding means (E2) when and while the second motor (M2) is put into action to pull the movable partition (10) towards the front of the container (1).

In the examples in FIGS. 6, 7 and 8, an alternative configuration may consist of not installing a gearbox (G) and connecting the first motor directly in line with the two reducers (R1, R2). In this case, the first motor may for example be a motor whose motor shaft is accessible from both sides, or it could be two motors whose motor shafts are preferably aligned and preferably rotate at the same speed, in one direction as well as the other.

According to some examples, the transmission ratio of the first speed reducer (R1) (output speed divided by input speed) is between ½ and 1/50.

According to some examples, the first speed reducer (R1) and the second speed reducer R2 have the same transmission ratio.

According to some examples, the first speed reducer (R1) includes a plurality of speed reducers mounted in cascade (in series).

According to some examples, the second speed reducer (R2) comprises a plurality of speed reducers mounted in cascade (in series).

According to some examples, the second transmission (T2) includes a speed reducer (R3) and the vehicle includes means for reducing a resistive torque of the second traction assembly (MT2) when and while the first traction assembly (MT1) is put into action to pull the movable partition toward the rear of the container.

According to a first example, the second motor (M2) is able to rotate in the two directions of rotation and the control unit is configured to:
rotate the second motor (M2) in a first direction of rotation to pull the movable partition (10) towards the front of the container (1), and to
rotate the second motor (M2) in a second direction of rotation opposite to the first direction of rotation when and while the first motor (M1) is put into action to pull the movable partition (10) towards the rear of the container (1).

According to another example, the second traction assembly (MT2) includes a third clutch (not shown) mounted between the speed reducer (R3) and the third winding means (E3). Preferably, the third clutch is a controllable clutch and the control unit is configured to disengage the third clutch when and while the control unit rotates the first motor (M1) in the first direction of rotation to pull the movable partition toward the rear of the container, and to engage the third clutch when and while the control unit rotates the second motor (M2) in a direction of rotation to pull the movable partition toward the front of the container.

According to some examples, the first and second flexible mechanical connections (14a, 14b) are cables or chains. According to some examples, the third flexible mechanical connection (14c) is a cable or a chain.

The first motor (M1) is for example a hydraulic motor and the second motor (M2) is for example an electric motor.

According to some examples, the container (1) is fixedly connected to the vehicle.

According to some examples, the first flexible mechanical connection (14a) and the second flexible mechanical connection (14b) form a single flexible mechanical connection. According to some examples, the single flexible mechanical connection is freely connected to the movable partition (10). By “freely connected”, it should be understood that the single flexible mechanical connection is not fixedly connected to the movable partition (10) but that the single flexible mechanical connection can move freely relative to the partition. Examples of such a unique flexible mechanical connection are provided in patent application WO2019154514 (see FIGS. 10, 11 and 12 and their description). Preferably, the single flexible mechanical connection is a cable, for example a braided steel cable, or a chain.

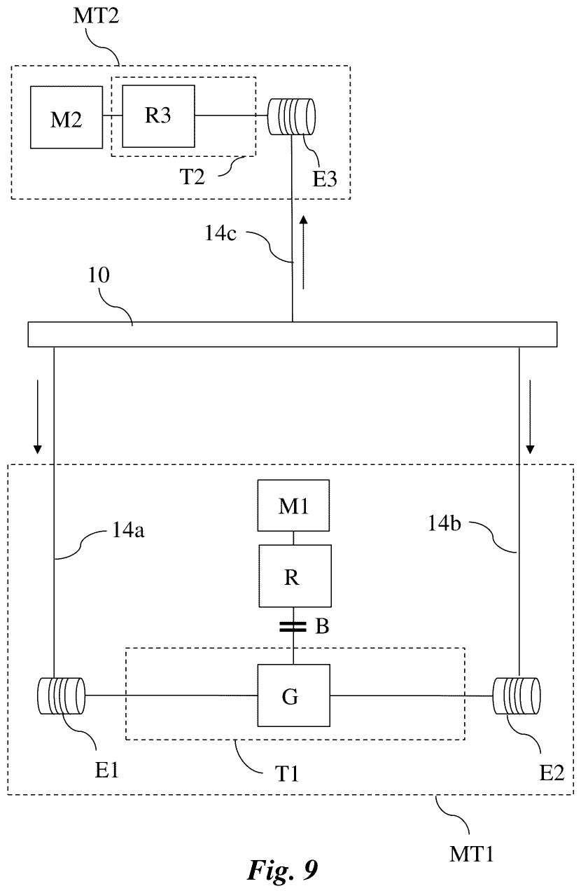

In FIGS. 5 to 8, the first motor (M1) is connected to the inputs of the two speed reducers (R1, R2) via a gearbox (G) allowing an angle transmission between the motor shaft and the input shafts of the speed reducers (R1, R2). Instead of having two speed reducers (R1, R2) mounted as illustrated in FIGS. 5 to 8, a single speed reducer mounted between the first motor (M1) and the gearbox (G) may alternatively be provided. If applicable, the clutch (B) in the example of FIG. 5 will be mounted downstream of the speed reducer, as shown in FIG. 9. In the example in FIG. 9, the clutch (B) is preferably a controllable clutch, and the vehicle comprises a control unit (not shown) configured to engage the clutch (B) when and while the first traction assembly (MT1) is put into action and to disengage the clutch (B) when and while the second traction assembly (MT2) is put into action.

In FIGS. 1 to 9, the second traction assembly (MT2) acts on one single flexible mechanical connection (14c), but it is alternatively possible to provide for several flexible mechanical connections, for example a fourth flexible mechanical connection (14d) one end of which is connected to a left part of the movable partition and a fifth flexible mechanical connection (14e) one end of which is connected to a right part of the movable partition, the opposite ends of the fourth and fifth flexible mechanical connections being connected together to an end of the third flexible mechanical connection (14c), an opposite end of the third flexible mechanical connection (14c) being connected to the third winding means (E3), as illustrated for example in FIG. 10, which also shows four angle deflection pulleys. According to some examples, the third, fourth and fifth flexible mechanical connections (14c, 14d, 14e) are cables or chains. In this example, the first traction assembly (MT1) may be any first traction assembly (MT1) as described above and the second traction assembly (MT2) may be any second traction assembly (MT2) as described above.

The invention also relates to a module or kit comprising the first traction assembly (MT1) and the second traction assembly (MT2) as well as optionally the control unit as described above, said module or kit able to be mounted on a vehicle whose container (1) is provided with the movable partition (10) as well as the flexible mechanical connections (14a, 14b, 14c, 14d, 14e) and pulleys as described above.

The present invention has been described in connection with specific embodiments, which have a purely illustrative value and should not be considered as restrictive. In general, it will be obvious to a person skilled in the art that the present invention is not limited to the examples illustrated and/or described above. The presence of reference numerals in the drawings should not be considered as restrictive, including when these numerals are indicated in the claims.

The use of the verbs “comprise”, “include”, “have” or any other variation, as well as their conjugations, cannot in any way exclude the presence of elements other than those mentioned.

The use of the indefinite article “a”, “an”, or of the definite article “the”, to introduce an element does not exclude the presence of a plurality of these elements.

An aspect of the invention may also be described as follows: a vehicle on which a container (1) is mounted for transporting materials, said container including a movable partition (10) extending transversely inside the container. The vehicle comprises a first traction assembly (MT1) capable of pulling by pulling on a pair of cables (14a, 14b) the front parts of which are connected on either side of the partition (10) in order to pull the partition (10) towards the rear of the container to unload materials from the vehicle.

The vehicle also comprises a second traction assembly (MT2) capable of pulling on one or more cables (14c, 14d, 14e, 14f) the front part(s) of which are connected to the movable partition (10) in order to pull the movable partition (10) towards the front of the container in order to place it again in an initial position at the front of the container before loading materials again.

1. Vehicle comprising a container for loading, transporting and unloading materials, said container extending longitudinally along a front-rear axis of the vehicle and comprising:
a left side wall and a right side wall,
a opening rear wall for unloading said materials,
a movable partition extending transversely inside the container,
a first flexible mechanical connection, a front part of which is connected to a left side of the partition and which first extends towards the rear of the vehicle, then upwards or downwards via at least one first pulley,
a second flexible mechanical connection, a front part of which is connected to a right side of the partition and which first extends towards the rear of the vehicle, then upwards or downwards via at least one second pulley,
at least one third flexible mechanical connection, a front part of which is connected to the partition and which first extends towards the front of the vehicle, then upwards or downwards via at least one third pulley,
a first traction assembly including a first motor and a first transmission, the first transmission having a first input connected to the first motor as well as a first output provided with a first winding means to which a left end of the first flexible mechanical connection is attached and a second output provided with a second winding means to which a right end of the second flexible mechanical connection is attached, the first transmission including at least one speed reducer for reducing a speed between the first input on the one hand and the first and second output on the other hand,
a second traction assembly including a second motor and a second transmission, the second transmission having a second input connected to the second motor as well as a second output provided with a third winding means to which an end of the third flexible mechanical connection is attached, the second transmission preferably including a speed reducer between the second motor and the third winding means,
a control unit configured to control the first traction assembly and the second traction assembly.

2. Vehicle according to claim 1, further including means for reducing a resistive torque of the first traction assembly when and while the second traction assembly is put into action.

3. Vehicle according to claim 2, wherein the first traction assembly comprises a clutch mounted between the first motor and the first transmission.

4. Vehicle according to claim 3, wherein the clutch is a controllable clutch, and wherein the control unit is configured to engage the clutch when and while the first traction assembly is put into action and to disengage the clutch when and while the second traction assembly is put into action.

5. Vehicle according to claim 2, wherein the first traction assembly comprises:
a first speed reducer mounted between the first motor and the first winding means,
a first clutch mounted between the first speed reducer and the first winding means,
a second speed reducer mounted between the first motor and the second winding means,
a second clutch mounted between the second speed reducer and the second winding means.

6. Vehicle according to claim 5, wherein the first and second clutches are controllable clutches, and wherein the control unit is configured to engage the first and second clutches when and while the first traction assembly is put into action and to disengage the first and second clutches when and while the second traction assembly is put into

7. Vehicle according to claim 2, wherein the first traction assembly comprises:
a first speed reducer mounted between the first motor and the first winding means,
a first freewheeling means mounted between the first speed reducer and the first winding means,
a second speed reducer mounted between the first motor and the second winding means,
a second freewheeling means mounted between the second speed reducer and the second winding means.

8. Vehicle according to claim 2, wherein the first motor is capable of rotating in two opposite directions of rotation and in wherein the control unit is configured to:
rotate the first motor in a first direction of rotation to pull the movable partition towards the rear of the container, and to
rotate the first motor in a second direction of rotation opposite to the first direction of rotation when and while the second motor is put into action to pull the movable partition towards the front of the container.

9. Vehicle according to any claim 1, wherein the second transmission comprises a speed reducer mounted between the second motor and the third winding means, and wherein the vehicle comprises means for reducing a resistive torque of the second traction assembly when and while the first traction assembly is put into action.

10. Vehicle according to claim 9, wherein the second motor is capable of rotating in two opposite directions of rotation and wherein the control unit is configured to:
rotate the second motor in a first direction of rotation to pull the movable partition towards the front of the container, and to
rotate the second motor in a second direction of rotation opposite to the first direction of rotation when and while the first motor is put into action to pull the movable partition towards the rear of the container.

11. Vehicle according to claim 9, wherein the second traction assembly includes a third clutch mounted between the third speed reducer and the third winding means.

12. Vehicle according to claim 11, wherein the third clutch is a controllable clutch and wherein the control unit is configured to disengage the third clutch when and while the control unit rotates the first motor in the first direction of rotation and to engage the third clutch when and while the control unit rotates the first motor in the second direction of rotation opposite to the first direction of rotation

13. Vehicle according to claim 1, wherein the first and second flexible mechanical connections are cables or chains.

14. Vehicle according to claim 1, wherein at least one of the at least one third flexible mechanical connection is a cable or a chain.

15. Vehicle according to claim 1, wherein the first motor is a hydraulic motor and in wherein the second motor is an electric motor.
